(19) United States
(12) Patent Application Publication
(10) Pub. No.: US 2022/0235715 A1
(43) Pub. Date: Jul. 28, 2022

(54) SYSTEM AND METHOD FOR FAULT SENSING FLOW COMPONENTS

(71) Applicant: General Electric Company, Schenectady, NY (US)

(72) Inventor: Jeffrey Douglas Rambo, Mason, OH (US)

(21) Appl. No.: 17/159,422

(22) Filed: Jan. 27, 2021

(51) Int. Cl. F02C 9/26; F02C 3/04

(52) U.S. Cl. CPC F02C 9/26; F02C 3/04; F05D 2270/3015; F05D 2260/80; F05D 2220/323

(57) ABSTRACT

A turbomachine for a vehicle is provided. The turbomachine includes a manifold configured to channel a flow of fluid therethrough; a first pressure measurement device in communication with the manifold and configured to determine a first pressure difference; a second pressure measurement device in communication with the manifold and configured to determine a second pressure difference; a data selector device in communication with the first pressure measurement device and the second pressure measurement device, wherein the data selector device receives the first and second pressure difference and uses a logic circuit to generate a single pressure signal; and an engine controller operably coupled to the data selector device such that the engine controller receives the single pressure signal indicating a pressure differential of the manifold.

### FIELD

The present disclosure relates generally to systems and methods for detecting fault conditions in flow components such as in gas turbine engines.

### BACKGROUND

Typical aircraft propulsion systems include one or more gas turbine engines. The gas turbine engines generally include a turbomachine, the turbomachine including, in serial flow order, a compressor section, a combustion section, a turbine section, and an exhaust section. In operation, air is provided to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere.

Certain operations and systems of the gas turbine engines and aircraft include fuel systems that deliver fuel and fluid systems that deliver fluids to various components of the engine and may be controlled by engine management systems. Detection and monitoring systems can be used with such fuel systems and fluid systems for monitoring of the systems of the engine.

### BRIEF DESCRIPTION

Aspects and advantages of the invention will be set forth in part in the following description, or may be obvious from the description, or may be learned through practice of the invention.

In one exemplary embodiment of the present disclosure, a turbomachine for a vehicle is provided. The turbomachine includes a manifold configured to channel a flow of fluid therethrough; a first pressure measurement device in communication with the manifold and configured to determine a first pressure difference (ΔP1); a second pressure measurement device in communication with the manifold and configured to determine a second pressure difference (ΔP2); a data selector device in communication with the first pressure measurement device and the second pressure measurement device, wherein the data selector device receives the first pressure difference (ΔP1) and the second pressure difference (ΔP2) and uses a logic circuit to generate a single pressure signal; and an engine controller operably coupled to the data selector device such that the engine controller receives the single pressure signal indicating a pressure differential of the manifold.

In certain exemplary embodiments the logic circuit is configured to determine if the first pressure difference and the second pressure difference are within a predetermined pressure range.

In certain exemplary embodiments when the logic circuit determines that both of the first pressure difference and the second pressure difference are within the predetermined pressure range, the logic circuit is configured to determine an average of the first pressure difference and the second pressure difference.

In certain exemplary embodiments when the logic circuit determines that both of the first pressure difference and the second pressure difference are outside of the predetermined pressure range, the logic circuit is configured to generate an error message.

In certain exemplary embodiments when the logic circuit determines that only one of the first pressure difference and the second pressure difference are within the predetermined pressure range, the logic circuit is configured to only use the one of the first pressure difference and the second pressure difference that is within the predetermined pressure range.

In certain exemplary embodiments the engine controller, in response to receiving the single pressure signal, compares the single pressure signal to a predetermined range.

In certain exemplary embodiments when the engine controller determines the single pressure signal is within the predetermined range, the engine controller detects a positive condition of the manifold, and when the engine controller determines the single pressure signal is outside of the predetermined range, the engine controller detects a fail condition of the manifold.

In certain exemplary embodiments the engine controller includes a monitoring system that indicates the positive condition or the fail condition of the manifold.

In certain exemplary embodiments the first pressure measurement device includes a first pressure sensor at a first upstream location and a second pressure sensor at a first downstream location, and the second pressure measurement device includes a third pressure sensor at a second upstream location and a fourth pressure sensor at a second downstream location.

In certain exemplary embodiments the turbomachine includes a valve disposed in a portion of the manifold, wherein the valve is transitionable between an open position and a closed position.

In another exemplary embodiment of the present disclosure, a computing system for a component of a vehicle is provided. The computing system includes a first pressure measurement device in communication with the component and configured to determine a first pressure difference (ΔP1); a second pressure measurement device in communication with the component and configured to determine a second pressure difference (ΔP2); a data selector device in communication with the first pressure measurement device and the second pressure measurement device, wherein the data selector device receives the first pressure difference (ΔP1) and the second pressure difference (ΔP2) and uses a logic circuit to generate a single pressure signal; and a controller having one or more processors and one or more memory devices, the one or more memory devices storing instructions that when executed by the one or more processors cause the one or more processors to perform operations, in performing the operations, the one or more processors are configured to receive the single pressure signal indicating a pressure differential of the component.

In certain exemplary embodiments the logic circuit is configured to determine if the first pressure difference and the second pressure difference are within a predetermined pressure range.

In certain exemplary embodiments when the logic circuit determines that both of the first pressure difference and the second pressure difference are within the predetermined pressure range, the logic circuit is configured to determine an average of the first pressure difference and the second pressure difference.

In certain exemplary embodiments when the logic circuit determines that both of the first pressure difference and the second pressure difference are outside of the predetermined pressure range, the logic circuit is configured to generate an error message.

In certain exemplary embodiments when the logic circuit determines that only one of the first pressure difference and the second pressure difference are within the predetermined pressure range, the logic circuit is configured to only use the one of the first pressure difference and the second pressure difference that is within the predetermined pressure range.

In certain exemplary embodiments the one or more processors are further configured to, in response to receiving the single pressure signal, compare the single pressure signal to a predetermined range.

In an exemplary aspect of the present disclosure, a method is provided for measuring pressure at a component of a vehicle. The method includes receiving, at a data selector device, two or more signals indicating a first and second pressure difference for the component; generating a single pressure signal from the first and second pressure difference; and receiving, by one or more computing devices, the single pressure signal indicating a pressure differential of the component.

In certain aspects the generating the single pressure signal from the first and second pressure difference comprises the data selector device using a logic circuit to generate the single pressure signal and the logic circuit is configured to determine if the first pressure difference and the second pressure difference are within a predetermined pressure range.

In certain aspects when the logic circuit determines that both of the first pressure difference and the second pressure difference are within the predetermined pressure range, the logic circuit is configured to determine an average of the first pressure difference and the second pressure difference.

In certain aspects when the logic circuit determines that both of the first pressure difference and the second pressure difference are outside of the predetermined pressure range, the logic circuit is configured to generate an error message.

These and other features, aspects and advantages of the present subject matter will become better understood with reference to the following description and appended claims. The accompanying drawings, which are incorporated in and constitute a part of this specification, illustrate embodiments of the subject matter and, together with the description, explain the principles of the subject matter.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a schematic cross-sectional view of an exemplary gas turbine engine in accordance with exemplary embodiments of the present disclosure.

FIG. 2 is a perspective view of an exemplary control system and manifold in accordance with exemplary embodiments of the present disclosure.

FIG. 3 is a side elevation view of an exemplary control system and manifold in accordance with exemplary embodiments of the present disclosure.

FIG. 4 is a rear elevation view of an exemplary control system and manifold in accordance with exemplary embodiments of the present disclosure.

FIG. 5 is a top elevation view of an exemplary control system and manifold in accordance with exemplary embodiments of the present disclosure.

FIG. 6 is a perspective view of an exemplary control system and manifold in accordance with another exemplary embodiment of the present disclosure.

FIG. 7 is a side elevation view of an exemplary control system and manifold in accordance with another exemplary embodiment of the present disclosure.

FIG. 8 is a rear elevation view of an exemplary control system and manifold in accordance with another exemplary embodiment of the present disclosure.

FIG. 9 is a side elevation view of an exemplary control system and manifold with a wall portion of the manifold hidden in accordance with exemplary embodiments of the present disclosure.

FIG. 10 is a top elevation view of an exemplary control system and manifold in accordance with exemplary embodiments of the present disclosure.

FIG. 11 provides a block diagram of a control system in accordance with exemplary embodiments of the present disclosure.

FIG. 12 is an example controller including a built-in status monitoring system according to exemplary embodiments of the present disclosure.

FIG. 13 is a flow diagram of an exemplary method of measuring pressure at a manifold of a vehicle in accordance with exemplary embodiments of the present disclosure.

FIG. 14 is an example computing system according to exemplary embodiments of the present disclosure.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “forward” and “aft” refer to relative positions within a gas turbine engine, with forward referring to a position closer to an engine inlet and aft referring to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Additionally, the terms “low,” “high,” or their respective comparative degrees (e.g., lower, higher, where applicable) each refer to relative speeds within an engine, unless otherwise specified. For example, a “low-pressure turbine” operates at a pressure generally lower than a “high-pressure turbine.” Alternatively, unless otherwise specified, the aforementioned terms may be understood in their superlative degree. For example, a “low-pressure turbine” may refer to the lowest maximum pressure turbine within a turbine section, and a “high-pressure turbine” may refer to the highest maximum pressure turbine within the turbine section.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin. Here and throughout the specification and claims, range limitations are combined and interchanged, such ranges are identified and include all the sub-ranges contained therein unless context or language indicates otherwise.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

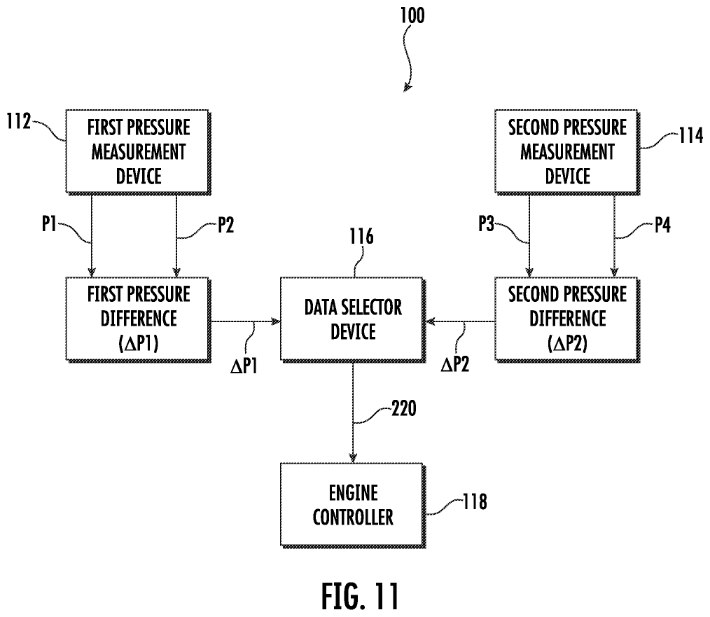

A vehicle of the present disclosure includes a control system that allows for a first pressure measurement device and a second pressure measurement device in communication with a component, e.g., a manifold or other fluid flow component, to each take a pressure reading at an upstream location of the manifold and at a downstream location of the manifold. These pressure readings are indicated in FIG. 11 at P1, P2, P3, and P4. This allows for the control system to determine a first pressure difference (ΔP1) and a second pressure difference (ΔP2). A data selector device of the control system receives the first pressure difference (ΔP1) and the second pressure difference (ΔP2) and uses a logic circuit to generate a single pressure signal. An engine controller is operably coupled to the data selector device such that the engine controller receives the single pressure signal indicating a pressure differential of the manifold. In this manner, advantageously, the control system of the present disclosure reduces multiple pressure readings P1, P2, P3, and P4, which each would need to be transmitted to a controller in multiple signals in conventional systems, to a single pressure signal that is sent to the engine controller. Thus, the control system of the present disclosure allows for a single signal to be transmitted to the engine controller thus reducing the space and/or number of channels required of the engine controller.

It is contemplated that the control system of the present disclosure can use an integrated differential pressure sensor array that measures static pressure differences through a component or manifold for detecting broken pipe conditions in fluid flow systems of a turbomachine or other components of other vehicles. It is envisioned that redundant differential pressure measurements across a manifold or other flow component provide robust detection of failed flow components, e.g., piping systems, and control logic of the control system requires positive indication from both pressure measurement devices to output an alarm signal or error message. It is also contemplated that control logic of a monitoring system of the present disclosure provides an alarm signal or error message to indicate fail conditions of a flow component, e.g., a manifold. For example, in exemplary embodiments, control logic of the control system requires positive indication from both pressure measurement devices to output an alarm signal. It is envisioned that an alarm system of the monitoring system may include a continuous signal with multiple alarm levels. For example, different indicators may be used to indicate different levels of the fail condition, e.g., high, medium, and low. The system of the present disclosure also provides for redundant differential pressure measurements combined into a single signal to reduce false positives.

For example, the logic circuit of the data selector device of the present disclosure is configured to determine if the first pressure difference and the second pressure difference are within a predetermined pressure range. In exemplary embodiments, when the logic circuit determines that both of the first pressure difference and the second pressure difference are within the predetermined pressure range, the logic circuit is configured to determine an average of the first pressure difference and the second pressure difference. In exemplary embodiments, when the logic circuit determines that both of the first pressure difference and the second pressure difference are outside of the predetermined pressure range, the logic circuit is configured to generate an error message. In exemplary embodiments, when the logic circuit determines that only one of the first pressure difference and the second pressure difference are within the predetermined pressure range, the logic circuit is configured to only use the one of the first pressure difference and the second pressure difference that is within the predetermined pressure range.

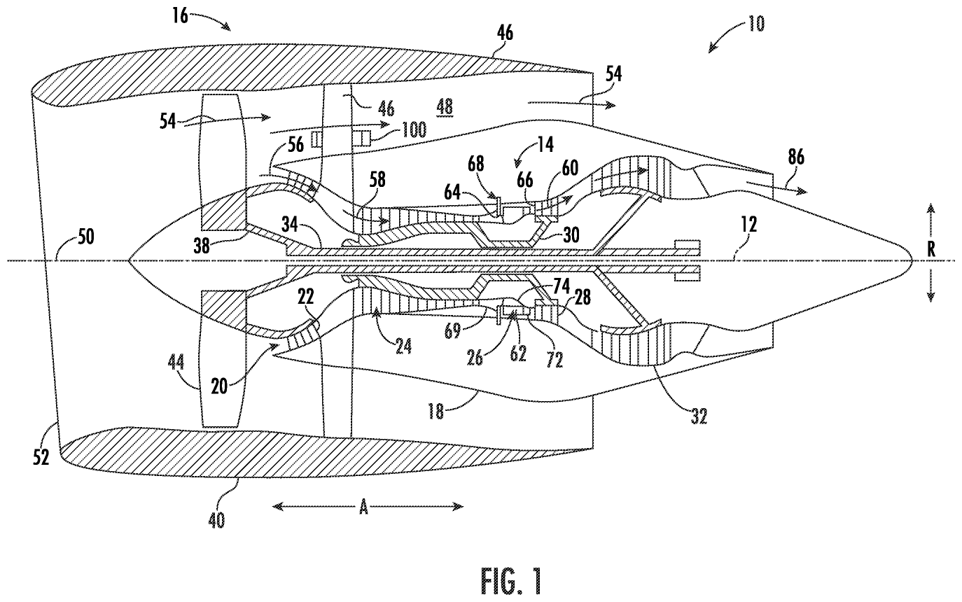

FIG. 1 provides a schematic cross-sectional view of an exemplary turbomachine as may incorporate various embodiments of the present disclosure. Particularly, FIG. 1 provides an aviation high-bypass turbofan engine or gas turbine engine 10. The turbofan 10 of FIG. 1 can be mounted to an aerial vehicle, such as a fixed-wing aircraft, and can produce thrust for propulsion of the aerial vehicle. For reference, the turbofan 10 defines an axial direction A, a radial direction R, and a circumferential direction. Moreover, the turbofan 10 defines an axial centerline or longitudinal axis 12 that extends therethrough for reference purposes. In general, the axial direction A extends parallel to the longitudinal axis 12, the radial direction R extends outward from and inward to the longitudinal axis 12 in a direction orthogonal to the axial direction A, and the circumferential direction extends three hundred sixty degrees (360°) around the longitudinal axis 12.

The turbofan 10 includes a core gas turbine engine 14 and a fan section 16 positioned upstream thereof. The core engine 14 includes a tubular outer casing 18 that defines an annular core inlet 20. The outer casing 18 further encloses and supports a booster or low pressure compressor 22 for pressurizing the air that enters core engine 14 through core inlet 20. A high pressure, multi-stage, axial-flow compressor 24 receives pressurized air from the LP compressor 22 and further increases the pressure of the air. The pressurized air stream flows downstream to a combustor 26 where fuel is injected into the pressurized air stream and ignited to raise the temperature and energy level of the pressurized air. The high energy combustion products flow from the combustor 26 downstream to a high pressure turbine 28 for driving the high pressure compressor 24 through a high pressure spool 30 or a second rotatable component. The high energy combustion products then flow to a low pressure turbine 32 for driving the LP compressor 22 and the fan section 16 through a low pressure spool 34 or a first rotatable component. The LP spool 34 is coaxial with the HP spool 30 in this example embodiment. After driving each of the turbines 28 and 32, the combustion products exit the core engine 14 through an exhaust nozzle 36 to produce propulsive thrust.

The fan section 16 includes a rotatable, axial-flow fan rotor 38 that is surrounded by an annular fan casing 40. The fan casing 40 is supported by the core engine 14 by a plurality of substantially radially-extending, circumferentially-spaced outlet guide vanes 42. In this way, the fan casing 40 encloses the fan rotor 38 and a plurality of fan blades 44. A downstream section 46 of the fan casing 40 extends over an outer portion of the core engine 14 to define a bypass passage 48. Air that passes through the bypass passage 48 provides propulsive thrust as will be explained further below. In some alternative embodiments, the LP spool 34 may be connected to the fan rotor 38 via a speed reduction device, such as a reduction gear gearbox in an indirect-drive or geared-drive configuration. Such speed reduction devices can be included between any suitable shafts/spools within the turbofan 10 as desired or required.

During operation of the turbofan 10, an initial or incoming airflow, represented by arrow 50, enters the turbofan 10 through an inlet 52 defined by the fan casing 40. The airflow 50 passes through the fan blades 44 and splits into a first air flow (represented by arrow 54) that moves through the bypass passage 48 and a second air flow (represented by arrow 56) which enters the LP compressor 22 through the core inlet 20.

The pressure of the second airflow 56 is progressively increased by the LP compressor 22 and then enters the HP compressor 24, as represented by arrow 58. The discharged pressurized air stream flows downstream to the combustor 26 where fuel is introduced to generate combustion gases or products. The combustion products 60 exit the combustor 26 and flow through the HP turbine 28. The combustion products 60 then flow through the LP turbine 32 and exit the exhaust nozzle 36 to produce thrust. Moreover, as noted above, a portion of the incoming airflow 50 flows through the bypass passage 48 and through an exit nozzle defined between the fan casing 40 and the outer casing 18 at the downstream section 46 of the fan casing 40. In this way, substantial propulsive thrust is produced.

As further shown in FIG. 1, the combustor 26 defines an annular combustion chamber 62 that is generally coaxial with the longitudinal centerline axis 12, as well as an inlet 64 and an outlet 66. The combustor 26 receives an annular stream of pressurized air from a high pressure compressor discharge outlet 69. A portion of this compressor discharge air (“CDP” air) flows into a mixer (not shown). Fuel is injected from a fuel nozzle 68 to mix with the air and form a fuel-air mixture that is provided to the combustion chamber 62 for combustion. Ignition of the fuel-air mixture is accomplished by a suitable igniter, and the resulting combustion gases 60 flow in an axial direction A toward and into an annular, first stage turbine nozzle 72. The nozzle 72 is defined by an annular flow channel that includes a plurality of radially-extending, circumferentially-spaced nozzle vanes 74 that turn the gases so that they flow angularly and impinge upon the first stage turbine blades of the HP turbine 28. For this embodiment, the HP turbine 28 rotates the HP compressor 24 via the HP spool 30 and the LP turbine 32 drives the LP compressor 22 and the fan rotor 38 via the LP spool 34.

Referring to FIG. 1, a control system or computing system 100 of the present disclosure may be in communication with a downstream section 46 of the fan casing 40 that extends over an outer portion of the core engine 14 to define a bypass passage 48. It is also contemplated that the control system 100 of the present disclosure may in communication with any other components of the core engine 14 that are configured to channel a flow of fluid or fuel therethrough.

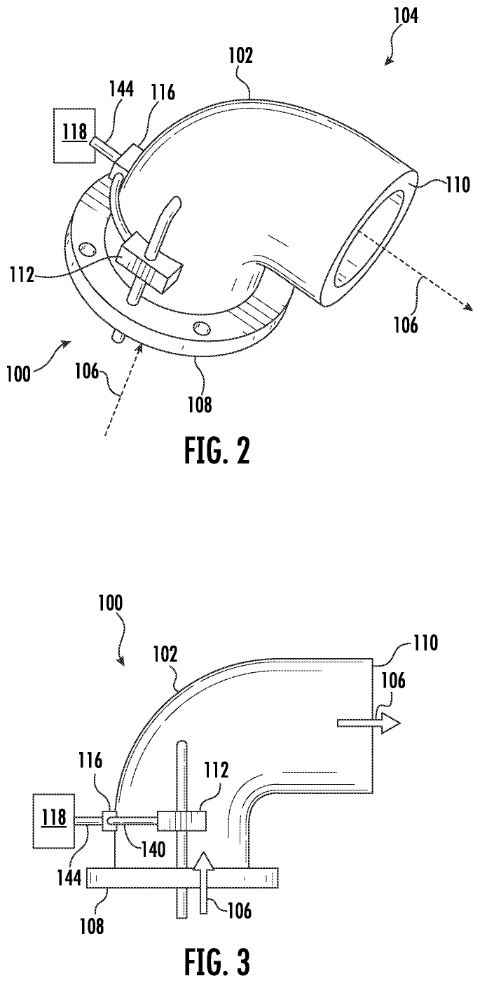

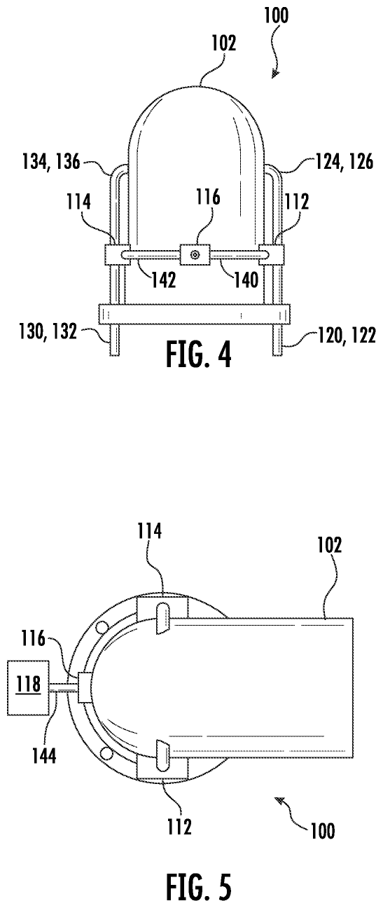

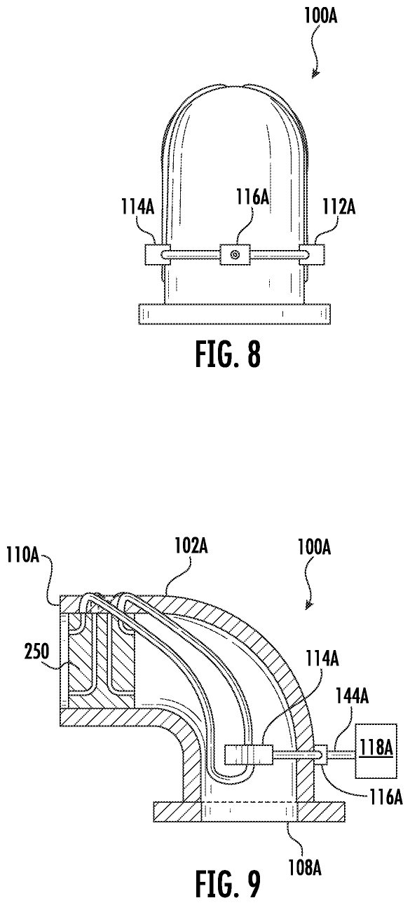

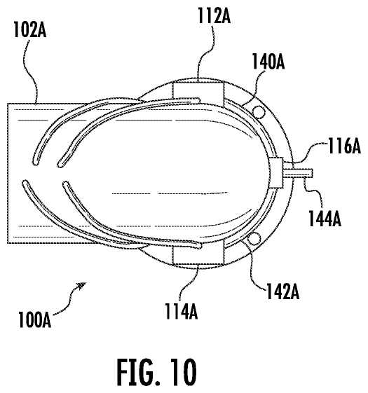

FIGS. 2-14 illustrate exemplary embodiments of the present disclosure. Referring to FIGS. 2-5, in an exemplary embodiment, a control or computing system 100 that may be used with the exemplary gas turbine engine 10 shown in FIG. 1. The computing system 100 is part of a system including a manifold or component 102 of a turbomachine 104. The manifold 102 is configured to channel a flow of fluid 106 therethrough. It is contemplated that the manifold 102 of the present disclosure may be any component of the core engine 14 that is configured to channel a flow of fluid or fuel therethrough. The flow of fluid 106 travels through the manifold 102 from an upstream portion 108 to a downstream portion 110.

Referring to FIGS. 2-5 and 11, in an exemplary embodiment, the control system 100 includes a first pressure measurement device 112, a second pressure measurement device 114, a data selector device 116, and an engine controller 118.

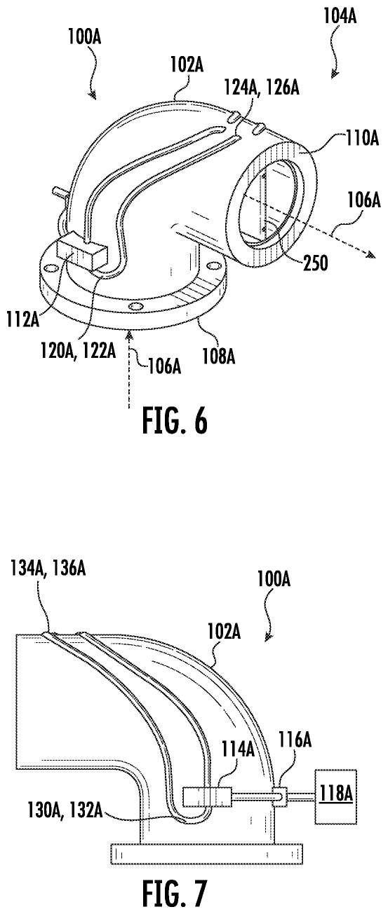

In exemplary embodiments, the first pressure measurement device 112 is in communication with the manifold 102 and is configured to determine a first pressure difference (ΔP1). For example, the first pressure measurement device 112 includes a first pressure sensor 120 at a first upstream location 122 and a second pressure sensor 124 at a first downstream location 126. The first pressure sensor 120 is configured to determine a first pressure reading P1 upstream of a portion of a component 128 or specific location of the manifold 102, e.g., it is also contemplated that the component may be a valve 250 (FIGS. 6-10) as described in detail below, and the second pressure sensor 124 is configured to determine a second pressure reading P2 downstream of the component 128 or specific location of the manifold 102, e.g., it is also contemplated that the component may be a valve 250 (FIGS. 6-10) as described in detail below. The first pressure reading P1 and the second pressure reading P2 are used to determine the first pressure difference (ΔP1) at a portion of the manifold 102.

In exemplary embodiments, the second pressure measurement device 114 is in communication with the manifold 102 and is configured to determine a second pressure difference (ΔP2). For example, the second pressure measurement device 114 includes a third pressure sensor 130 at a second upstream location 132 and a fourth pressure sensor 134 at a second downstream location 136. The third pressure sensor 130 is configured to determine a third pressure reading P3 upstream of a portion of a component 128 or specific location of the manifold 102, e.g., it is also contemplated that the component may be a valve 250 (FIGS. 6-10) as described in detail below, and the fourth pressure sensor 134 is configured to determine a fourth pressure reading P4 downstream of the component 128 or specific location of the manifold 102, e.g., it is also contemplated that the component may be a valve 250 (FIGS. 6-10) as described in detail below. The third pressure reading P3 and the fourth pressure reading P4 are used to determine the second pressure difference (ΔP2) at a portion of the manifold 102. In exemplary embodiments, it is envisioned that the first pressure measurement device 112 and the second pressure measurement device 114 may include pressure transducers, sensors, or other sensing components. It is envisioned that the control system 100 and manifold 102 of the present disclosure is a cavity off-take elbow that can have a plenum to elbow static pressure difference measured and monitored by the control system 100 of the present disclosure. In other exemplary embodiments, the control system 100 of the present disclosure can measure and monitor static pressure differences of any cavity, flow regions, or components of a vehicle.

In exemplary embodiments, the data selector device 116 is in communication with the first pressure measurement device 112 and the second pressure measurement device 114. For example, referring to FIGS. 2-5, the data selector device 116 is in communication with the first pressure measurement device 112 via a first signal line 140 and the data selector device 116 is in communication with the second pressure measurement device 114 via a second signal line 142. It is also contemplated that the data selector device 116 is in communication with the first pressure measurement device 112 and the second pressure measurement device 114 via other communication means such as via a wireless communication system.

The data selector device 116 receives the first pressure difference (ΔP1) and the second pressure difference (ΔP2) and uses a logic circuit to generate a single pressure signal 220. Importantly, in this manner, a single pressure signal 220 is transmitted to the engine controller 118 as shown in FIG. 11. For example, the logic circuit of the data selector device 116 of the present disclosure is configured to determine if the first pressure difference (ΔP1) and the second pressure difference (ΔP2) are within a predetermined pressure range. In exemplary embodiments, when the logic circuit determines that both of the first pressure difference (ΔP1) and the second pressure difference (ΔP2) are within the predetermined pressure range, the logic circuit is configured to determine an average of the first pressure difference (ΔP1) and the second pressure difference (ΔP2). In exemplary embodiments, when the logic circuit determines that both of the first pressure difference (ΔP1) and the second pressure difference (ΔP2) are outside of the predetermined pressure range, the logic circuit is configured to generate an error message. In exemplary embodiments, when the logic circuit determines that only one of the first pressure difference (ΔP1) and the second pressure difference (ΔP2) are within the predetermined pressure range, the logic circuit is configured to only use the one of the first pressure difference (ΔP1) and the second pressure difference (ΔP2) that is within the predetermined pressure range. It is envisioned that any number of logic circuits can be used, such as an AND logic gate.

It is contemplated that the predetermined pressure range can be any desired range or calculated range for a particular flow application for any flow components of a turbomachine 104. For example, calculations can be made for a particular flow application to determine an appropriate predetermined pressure range.

In an exemplary embodiment, the data selector device 116 comprises a multiplexer, although other components are contemplated. For example, the data selector device 116 may be an electronic device, a programmable device or circuit that sends out an electrical signal based on some logic, or a pressure signal device that is able to read an analog pressure gauge and send a pressure signal.

In exemplary embodiments, the engine controller 118 is operably coupled to the data selector device 116 such that the engine controller 118 receives the single pressure signal 220 indicating a pressure differential of the manifold 102; and in response to receiving the single pressure signal 220, compares the single pressure signal 220 to a predetermined range. It is contemplated that the engine controller 118 may be any electronic device or other programmable device or circuit that is able to send out an electrical signal.

It is envisioned that the engine controller 118 may be coupled to the data selector device 116 via a third signal line 144. It is also contemplated that the data selector device 116 is in communication with the engine controller 118 via other communication means such as via a wireless communication system.

In the control system 100 of the present disclosure, when the engine controller 118 determines the single pressure signal 220 is within the predetermined range, the engine controller 118 detects a positive condition of the manifold 102. Furthermore, when the engine controller 118 determines the single pressure signal 220 is outside of the predetermined range, the engine controller 118 detects a fail condition of the manifold 102. It is contemplated that the predetermined range can be any desired range for a manifold 102 or other component of a turbomachine 104 to indicate a positive condition or a fail condition of the component. For example, the measuring of a static pressure difference through such a manifold or other component 102 allows for the detection of, for example, a broken pipe condition in a flow or fuel system of a gas turbine engine 10.

FIG. 11 provides a schematic view of the control system 100 for a vehicle of the present disclosure. As described herein, importantly, the control system 100 of the present disclosure allows for a first pressure measurement device 112 and a second pressure measurement device 114 in communication with a component, e.g., a manifold 102 (FIGS. 2-5), to each take a pressure reading at an upstream location of the manifold 102 and at a downstream location of the manifold 102. These pressure readings are indicated in FIG. 11 at P1, P2, P3, and P4. This allows for the control system 100 to determine a first pressure difference (ΔP1) and a second pressure difference (ΔP2). The data selector device 116 of the control system 100 receives the first pressure difference (ΔP1) and the second pressure difference (ΔP2) and uses a logic circuit to generate a single pressure signal 220. The engine controller 118 is operably coupled to the data selector device 116 such that the engine controller 118 receives the single pressure signal 220 indicating a pressure differential of the manifold 102; and in response to receiving the single pressure signal 220, compares the single pressure signal 220 to a predetermined range. In this manner, advantageously, the control system 100 of the present disclosure reduces multiple pressure readings P1, P2, P3, and P4, which each would need to be transmitted to a controller in multiple signals in conventional systems, to a single pressure signal 220 that is sent to the engine controller 118. Thus, the control system 100 of the present disclosure allows for a single signal to be transmitted to the engine controller 118 thus reducing the space and/or number of channels required of the engine controller 118.

It is contemplated that the control system 100 of the present disclosure can use an integrated differential pressure sensor array that measures static pressure differences through a component or manifold 102 for detecting broken pipe conditions in fluid flow systems of a turbomachine 104 or other components of other vehicles. It is envisioned that redundant differential pressure measurements across a manifold or other flow component provide robust detection of failed flow components, e.g., piping systems, and control logic of the control system 100 requires positive indication from both pressure measurement devices to output an alarm signal or error message. It is also contemplated that control logic of the monitoring system 300 provides an alarm signal or error message to indicate fail conditions of a flow component, e.g., a manifold 102. For example, in exemplary embodiments, control logic of the control system 100 requires positive indication from both pressure measurement devices to output an alarm signal or error message. It is envisioned that an alarm system of the monitoring system 300 may include a continuous signal with multiple alarm levels. For example, different indicators may be used to indicate different levels of the fail condition, e.g., high, medium, and low. The system of the present disclosure also provides for redundant differential pressure measurements combined into a single signal to reduce false positives.

In some exemplary embodiments, all of the components of the control system 100 are onboard the turbofan 10. In other embodiments, some of the components of the control system 100 are onboard the turbofan 10 and some are offboard the turbofan 10. For instance, some of the offboard components can be mounted to a wing, fuselage, or other suitable structure of an aerial vehicle to which the turbofan 10 is mounted.

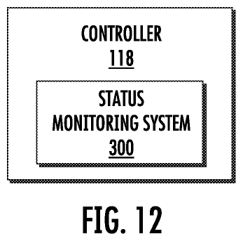

Furthermore, referring to FIG. 12, the control system 100 of the present disclosure includes a controller 130 having a built-in status monitoring system 300. The built-in status monitoring system 300 is able to indicate a status of the manifold or other component 102 of a gas turbine engine 10. For example, the monitoring system 300 indicates the positive condition or the fail condition of the manifold 102. It is also contemplated that the status monitoring system 300 may be able to provide indication of other states of the manifold 102 or other components of the gas turbine engine 10. It is contemplated that control logic of the monitoring system 300 provides an alarm signal or error message to indicate fail conditions of a flow component, e.g., a manifold 102. For example, in exemplary embodiments, control logic of the control system 100 requires positive indication from both pressure measurement devices to output an alarm signal or error message. It is envisioned that an alarm system of the monitoring system 300 may include a continuous signal with multiple alarm levels. For example, different indicators may be used to indicate different levels of the fail condition, e.g., high, medium, and low.

FIGS. 6-10 illustrate another exemplary embodiment of the present disclosure. The embodiment illustrated in FIGS. 6-10 includes similar components to the embodiment illustrated in FIGS. 2-5, and the similar components are denoted by a reference number followed by the letter A. For the sake of brevity, these similar components and the similar steps of using control system 100A (FIGS. 6-10) will not all be discussed in conjunction with the embodiments illustrated in FIGS. 6-10.

Referring to FIGS. 6-10, the control system 100A of the present disclosure may include a valve 250 disposed in a portion of the manifold 102A. The valve 250 is transitionable between an open position and a closed position. In this manner, the first pressure sensor 120A is configured to determine a first pressure reading P1 upstream of the valve 250 and the second pressure sensor 124A is configured to determine a second pressure reading P2 downstream of the valve 250. The first pressure reading P1 and the second pressure reading P2 are used to determine the first pressure difference (ΔP1) at a portion of the manifold 102. Furthermore, the third pressure sensor 130A is configured to determine a third pressure reading P3 upstream of the valve 250 and the fourth pressure sensor 134A is configured to determine a fourth pressure reading P4 downstream of the valve 250 (FIGS. 6-10). The third pressure reading P3 and the fourth pressure reading P4 are used to determine the second pressure difference (ΔP2) at a portion of the manifold 102.

In this manner, a control system 100A of the present disclosure can be used to determine if there is blockage at the valve 250, e.g., if debris or other contaminants are keeping the valve 250 open when the valve 250 should be closed or if the valve 250 is failing. It is contemplated that the control system 100A of the present disclosure can also determine by a large change in the differential pressure if the valve 250 is in an open position or a closed position. The system of the present disclosure also provides for redundant differential pressure measurements combined into a single signal to reduce false positives.

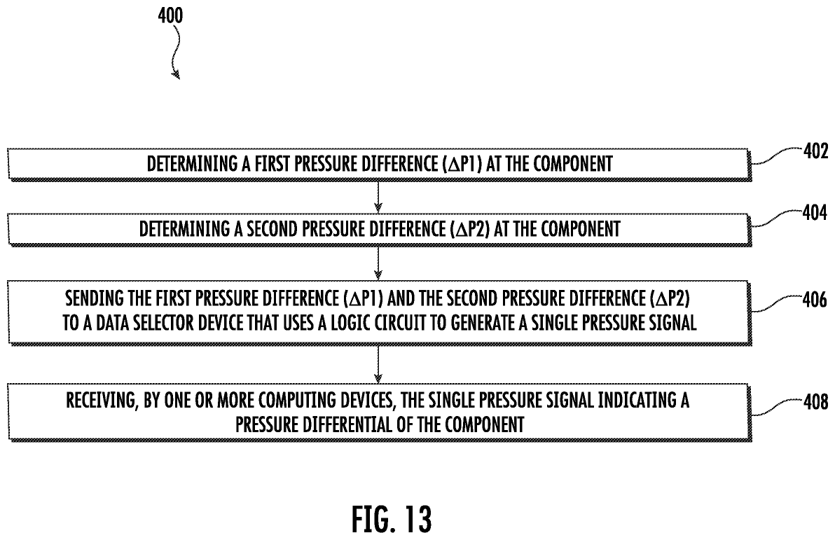

FIG. 13 provides a flow diagram of an exemplary method (400) of measuring pressure at a manifold or component of a vehicle in accordance with exemplary embodiments of the present disclosure. For instance, the exemplary method (400) may be utilized for operating the engine 10 described herein. It should be appreciated that the method (400) is discussed herein only to describe exemplary aspects of the present subject matter and is not intended to be limiting. In an exemplary embodiment, the method (400) of measuring pressure at a component of a vehicle includes receiving, at a data selector device, two or more signals indicating a first and second pressure difference for the component; generating a single pressure signal from the first and second pressure difference; and receiving, by one or more computing devices, the single pressure signal indicating a pressure differential of the component.

In other exemplary embodiments, at (402), the method (400) includes determining a first pressure difference (ΔP1) at the component. Next, at (404), the method (400) includes determining a second pressure difference (ΔP2) at the component.

At (406), the method (400) includes sending the first pressure difference (ΔP1) and the second pressure difference (ΔP2) to a data selector device that uses a logic circuit to generate a single pressure signal. Next, at (408), the method (400) includes receiving, by one or more computing devices, the single pressure signal indicating a pressure differential of the component.

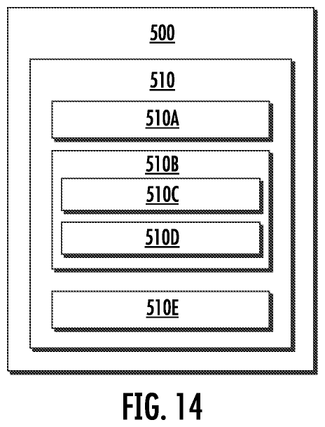

FIG. 14 provides an example computing system 500 according to example embodiments of the present disclosure. The computing systems (e.g., the controller 118) described herein may include various components and perform various functions of the computing system 500 described below, for example.

As shown in FIG. 14, the computing system 500 can include one or more computing device(s) 510. The computing device(s) 510 can include one or more processor(s) 510A and one or more memory device(s) 510B. The one or more processor(s) 510A can include any suitable processing device, such as a microprocessor, microcontroller, integrated circuit, logic device, and/or other suitable processing device. The one or more memory device(s) 510B can include one or more computer-readable media, including, but not limited to, non-transitory computer-readable media, RAM, ROM, hard drives, flash drives, and/or other memory devices.

The one or more memory device(s) 510B can store information accessible by the one or more processor(s) 510A, including computer-readable instructions 510C that can be executed by the one or more processor(s) 510A. The instructions 510C can be any set of instructions that when executed by the one or more processor(s) 510A, cause the one or more processor(s) 510A to perform operations. In some embodiments, the instructions 510C can be executed by the one or more processor(s) 510A to cause the one or more processor(s) 510A to perform operations, such as any of the operations and functions for which the computing system 500 and/or the computing device(s) 510 are configured, operations for electrically assisting a turbomachine during transient operation (e.g., method (400)), and/or any other operations or functions of the one or more computing device(s) 510. Accordingly, the method (400) may be a computer-implemented method, such that each of the steps of the exemplary method (400) are performed by one or more computing devices, such as the exemplary computing device 510 of the computing system 500. The instructions 510C can be software written in any suitable programming language or can be implemented in hardware. Additionally, and/or alternatively, the instructions 510C can be executed in logically and/or virtually separate threads on processor(s) 510A. The memory device(s) 510B can further store data 510D that can be accessed by the processor(s) 510A. For example, the data 510D can include models, databases, etc.

The computing device(s) 510 can also include a network interface 510E used to communicate, for example, with the other components of system 500 (e.g., via a network). The network interface 510E can include any suitable components for interfacing with one or more network(s), including for example, transmitters, receivers, ports, controllers, antennas, and/or other suitable components. One or more external devices, such as fuel control device(s) 150 and electrical control device(s) 120, can be configured to receive one or more commands from the computing device(s) 510 or provide one or more commands to the computing device(s) 510.

It is contemplated that the turbomachines and methods of the present disclosure may be implemented on an aircraft, helicopter, automobile, boat, submarine, train, unmanned aerial vehicle or drone and/or on any other suitable vehicle. While the present disclosure is described herein with reference to an aircraft implementation, this is intended only to serve as an example and not to be limiting. One of ordinary skill in the art would understand that the turbomachines and methods of the present disclosure may be implemented on other vehicles without deviating from the scope of the present disclosure.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

Further aspects of the invention are provided by the subject matter of the following clauses:

1. A turbomachine for a vehicle, comprising: a manifold configured to channel a flow of fluid therethrough; a first pressure measurement device in communication with the manifold and configured to determine a first pressure difference (ΔP1); a second pressure measurement device in communication with the manifold and configured to determine a second pressure difference (ΔP2); a data selector device in communication with the first pressure measurement device and the second pressure measurement device, wherein the data selector device receives the first pressure difference (ΔP1) and the second pressure difference (ΔP2) and uses a logic circuit to generate a single pressure signal; and an engine controller operably coupled to the data selector device such that the engine controller receives the single pressure signal indicating a pressure differential of the manifold.

2. The turbomachine of any preceding clause, wherein the logic circuit is configured to determine if the first pressure difference and the second pressure difference are within a predetermined pressure range.

3. The turbomachine of any preceding clause, wherein when the logic circuit determines that both of the first pressure difference and the second pressure difference are within the predetermined pressure range, the logic circuit is configured to determine an average of the first pressure difference and the second pressure difference.

4. The turbomachine of any preceding clause, wherein when the logic circuit determines that both of the first pressure difference and the second pressure difference are outside of the predetermined pressure range, the logic circuit is configured to generate an error message.

5. The turbomachine of any preceding clause, wherein when the logic circuit determines that only one of the first pressure difference and the second pressure difference are within the predetermined pressure range, the logic circuit is configured to only use the one of the first pressure difference and the second pressure difference that is within the predetermined pressure range.

6. The turbomachine of any preceding clause, wherein the engine controller, in response to receiving the single pressure signal, compares the single pressure signal to a predetermined range.

7. The turbomachine of any preceding clause, wherein when the engine controller determines the single pressure signal is within the predetermined range, the engine controller detects a positive condition of the manifold, and wherein when the engine controller determines the single pressure signal is outside of the predetermined range, the engine controller detects a fail condition of the manifold.

8. The turbomachine of any preceding clause, wherein the engine controller includes a monitoring system that indicates the positive condition or the fail condition of the manifold.

9. The turbomachine of any preceding clause, wherein the first pressure measurement device includes a first pressure sensor at a first upstream location and a second pressure sensor at a first downstream location, and wherein the second pressure measurement device includes a third pressure sensor at a second upstream location and a fourth pressure sensor at a second downstream location.

10. The turbomachine of any preceding clause, further comprising a valve disposed in a portion of the manifold, wherein the valve is transitionable between an open position and a closed position.

11. A computing system for a component of a vehicle, comprising: a first pressure measurement device in communication with the component and configured to determine a first pressure difference (ΔP1); a second pressure measurement device in communication with the component and configured to determine a second pressure difference (ΔP2); a data selector device in communication with the first pressure measurement device and the second pressure measurement device, wherein the data selector device receives the first pressure difference (ΔP1) and the second pressure difference (ΔP2) and uses a logic circuit to generate a single pressure signal; and a controller having one or more processors and one or more memory devices, the one or more memory devices storing instructions that when executed by the one or more processors cause the one or more processors to perform operations, in performing the operations, the one or more processors are configured to receive the single pressure signal indicating a pressure differential of the component.

12. The computing system of any preceding clause, wherein the logic circuit is configured to determine if the first pressure difference and the second pressure difference are within a predetermined pressure range.

13. The computing system of any preceding clause, wherein when the logic circuit determines that both of the first pressure difference and the second pressure difference are within the predetermined pressure range, the logic circuit is configured to determine an average of the first pressure difference and the second pressure difference.

14. The computing system of any preceding clause, wherein when the logic circuit determines that both of the first pressure difference and the second pressure difference are outside of the predetermined pressure range, the logic circuit is configured to generate an error message.

15. The computing system of any preceding clause, wherein when the logic circuit determines that only one of the first pressure difference and the second pressure difference are within the predetermined pressure range, the logic circuit is configured to only use the one of the first pressure difference and the second pressure difference that is within the predetermined pressure range.

16. The computing system of any preceding clause, wherein the one or more processors are further configured to, in response to receiving the single pressure signal, compare the single pressure signal to a predetermined range.

17. A method of measuring pressure at a component of a vehicle, the method comprising: receiving, at a data selector device, two or more signals indicating a first and second pressure difference for the component; generating a single pressure signal from the first and second pressure difference; and receiving, by one or more computing devices, the single pressure signal indicating a pressure differential of the component.

18. The method of any preceding clause, wherein the generating the single pressure signal from the first and second pressure difference comprises the data selector device using a logic circuit to generate the single pressure signal, wherein the logic circuit is configured to determine if the first pressure difference and the second pressure difference are within a predetermined pressure range.

19. The method of any preceding clause, wherein when the logic circuit determines that both of the first pressure difference and the second pressure difference are within the predetermined pressure range, the logic circuit is configured to determine an average of the first pressure difference and the second pressure difference.

20. The method of any preceding clause, wherein when the logic circuit determines that both of the first pressure difference and the second pressure difference are outside of the predetermined pressure range, the logic circuit is configured to generate an error message.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

While this disclosure has been described as having exemplary designs, the present disclosure can be further modified within the scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A turbomachine for a vehicle, comprising:
a manifold configured to channel a flow of fluid therethrough;
a first pressure measurement device in communication with the manifold and configured to determine a first pressure difference;
a second pressure measurement device in communication with the manifold and configured to determine a second pressure difference;
a data selector device in communication with the first pressure measurement device and the second pressure measurement device, wherein the data selector device receives the first pressure difference and the second pressure difference and uses a logic circuit to generate a single pressure signal; and
an engine controller operably coupled to the data selector device such that the engine controller receives the single pressure signal indicating a pressure differential of the manifold.

2. The turbomachine of claim 1, wherein the logic circuit is configured to determine if the first pressure difference and the second pressure difference are within a predetermined pressure range.

3. The turbomachine of claim 2, wherein when the logic circuit determines that both of the first pressure difference and the second pressure difference are within the predetermined pressure range, the logic circuit is configured to determine an average of the first pressure difference and the second pressure difference.

4. The turbomachine of claim 2, wherein when the logic circuit determines that both of the first pressure difference and the second pressure difference are outside of the predetermined pressure range, the logic circuit is configured to generate an error message.

5. The turbomachine of claim 2, wherein when the logic circuit determines that only one of the first pressure difference and the second pressure difference are within the predetermined pressure range, the logic circuit is configured to only use the one of the first pressure difference and the second pressure difference that is within the predetermined pressure range.

6. The turbomachine of claim 1, wherein the engine controller, in response to receiving the single pressure signal, compares the single pressure signal to a predetermined range.

7. The turbomachine of claim 6, wherein when the engine controller determines the single pressure signal is within the predetermined range, the engine controller detects a positive condition of the manifold, and wherein when the engine controller determines the single pressure signal is outside of the predetermined range, the engine controller detects a fail condition of the manifold.

8. The turbomachine of claim 7, wherein the engine controller includes a monitoring system that indicates the positive condition or the fail condition of the manifold.

9. The turbomachine of claim 1, wherein the first pressure measurement device includes a first pressure sensor at a first upstream location and a second pressure sensor at a first downstream location, and wherein the second pressure measurement device includes a third pressure sensor at a second upstream location and a fourth pressure sensor at a second downstream location.

10. The turbomachine of claim 9, further comprising a valve disposed in a portion of the manifold, wherein the valve is transitionable between an open position and a closed position.

11. A computing system for a component of a vehicle, comprising:
a first pressure measurement device in communication with the component and configured to determine a first pressure difference;
a second pressure measurement device in communication with the component and configured to determine a second pressure difference;
a data selector device in communication with the first pressure measurement device and the second pressure measurement device, wherein the data selector device receives the first pressure difference and the second pressure difference and uses a logic circuit to generate a single pressure signal; and
a controller having one or more processors and one or more memory devices, the one or more memory devices storing instructions that when executed by the one or more processors cause the one or more processors to perform operations, in performing the operations, the one or more processors are configured to receive the single pressure signal indicating a pressure differential of the component.

12. The computing system of claim 11, wherein the logic circuit is configured to determine if the first pressure difference and the second pressure difference are within a predetermined pressure range.

13. The computing system of claim 12, wherein when the logic circuit determines that both of the first pressure difference and the second pressure difference are within the predetermined pressure range, the logic circuit is configured to determine an average of the first pressure difference and the second pressure difference.

14. The computing system of claim 12, wherein when the logic circuit determines that both of the first pressure difference and the second pressure difference are outside of the predetermined pressure range, the logic circuit is configured to generate an error message.

15. The computing system of claim 12, wherein when the logic circuit determines that only one of the first pressure difference and the second pressure difference are within the predetermined pressure range, the logic circuit is configured to only use the one of the first pressure difference and the second pressure difference that is within the predetermined pressure range.

16. The computing system of claim 11, wherein the one or more processors are further configured to, in response to receiving the single pressure signal, compare the single pressure signal to a predetermined range.

17. A method of measuring pressure at a component of a vehicle, the method comprising:
receiving, at a data selector device, two or more signals indicating a first and second pressure difference for the component;
generating a single pressure signal from the first and second pressure difference; and
receiving, by one or more computing devices, the single pressure signal indicating a pressure differential of the component.

18. The method of claim 17, wherein the generating the single pressure signal from the first and second pressure difference comprises the data selector device using a logic circuit to generate the single pressure signal, wherein the logic circuit is configured to determine if the first pressure difference and the second pressure difference are within a predetermined pressure range.

19. The method of claim 18, wherein when the logic circuit determines that both of the first pressure difference and the second pressure difference are within the predetermined pressure range, the logic circuit is configured to determine an average of the first pressure difference and the second pressure difference.

20. The method of claim 18, wherein when the logic circuit determines that both of the first pressure difference and the second pressure difference are outside of the predetermined pressure range, the logic circuit is configured to generate an error message.
